(19) United States
(12) Patent Application Publication
(10) Pub. No.: US 2009/0157616 A1
(43) Pub. Date: Jun. 18, 2009

(54) System and method for enabling a user to search and retrieve individual topics in a visual mapping system

(76) Inventors: Richard Barber, Berkeley, CA (US); Peter Hizalev, San Francisco, CA (US); Andrew Mochalskyy, San Francisco, CA (US); Stefan Funk, Larkspur, CA (US)

Correspondence Address: Tina M. Lessani;Lessani & Lessani LLP, 163 Cypress Point Road, Half Bay Moon, CA, 94019, US

(21) Appl. No.: 12/001,533

(22) Filed: Dec. 12, 2007

(51) Int. Cl. G06F 7/06

(52) U.S. Cl. 707/3; 707/E17.014

(57) ABSTRACT

The present invention provides a system and method for storing, searching, and retrieving topics in a visual map. The visual mapping system of the present invention is based on a client-server architecture. Client visual mapping applications on users' computers enable users to create, edit, and view visual maps. The storage and retrieval of data associated with such visual maps is managed by a server in the visual mapping system. The server stores the topics in the visual map in a database. The topics are stored individually and not as part of a visual map file. The topics are indexed to enable the system to quickly perform searches for the topic. The client visual mapping application includes an interface through which a user can enter search criteria for a topic search. Because topics are stored individually in the database and indexed, user can search for topics individually and separately from the visual map file associated with the topics. Topics can be shared across users and across maps. Also, user can simultaneously, view, edit and collaborate on different topics associated with the same map file.

### BACKGROUND OF THE INVENTION

1. Field of the Invention

This invention relates generally to visual mapping systems, and, more particularly, to enabling users to search and retrieve topics in a visual map on an individual basis.

2. Description of the Background Art

A visual map is a diagram that represents ideas and/or information in topics. Examples of visual maps are mind maps, topic maps, semantic networks, and concept maps. Visual maps are increasingly used to help people generate, classify, and/or organize ideas and information and to see such ideas and information in a hierarchical, visual layout.

Visual maps are used for project management, work-flow analysis, organizational charts, and other purposes. FIG. 1 is an example of a visual map for information related to a wireless communication project meeting. The visual map in FIG. 1 is a mind map. Mind maps are made up of hierarchically-arranged topics. The main topics in FIG. 1 are “Action Items”, “Purpose”, “Agenda”, “Time Place”, “Participants”, and “Purpose.” Each of these topics has subtopics. For instance, “Implementation” is a subtopic for “Action Items,” and “Carry out Launch” is a subtopic of “Implementation.”

There are software programs that enable people to easily create visual maps. Mindjet, Inc.'s MindManager software is an example of such software.

In known systems, topics in a visual map are stored as part of a visual map file. Users cannot search for topics independent of the map file in which the topic resides. In other words, users can search and retrieve maps, but not topics individually. It is desirable to have a visual mapping system that enables users to search and retrieve topics individually to enable topics to be easily shared across maps and users and to enable users to simultaneously edit different topics in the same map.

### SUMMARY

The present invention provides a system and method for storing, searching, and retrieving topics in a visual map. The visual mapping system of the present invention is based on a client-server architecture.

In the present invention, client visual mapping applications on users' computers enable users to create, edit, and view visual maps. The storage and retrieval of data associated with such visual maps is managed by a server in the visual mapping system. The server stores the topics in the visual map in a database. The topics are stored individually and not as part of a visual map file. The topics are indexed to enable the system to quickly perform searches for one or more topics.

The client visual mapping application includes an interface through which a user can enter search criteria for a topic search. Because topics are stored individually in the database and indexed, user can search for topics individually and separately from the visual map file associated with the topics. This means that topics can be shared across users and across maps. Also, users can simultaneously, view, edit and collaborate on different topics associated with the same map.

### BRIEF DESCRIPTION OF THE DRAWINGS

FIGS. 1 is an example of a mind map.

FIG. 2 is a flow chart that illustrates a method for storing, searching, and retrieving topics in a visual mapping system in a manner that enables users to search for and retrieve topics individually.

FIGS. 3a-3c illustrate an example of a “dashboard” visual map.

FIG. 4 is a block diagram of an example visual mapping system according to one embodiment of the present invention.

FIGS. 5a-5c illustrate an example of how topics are stored in a database.

FIGS. 6a-6c illustrate an example of how workspaces are stored in a database.

FIGS. 7 and 8 are example visual maps discussed in conjunction with FIGS. 5a-5c and 6a-c.

FIGS. 9a-9c illustrate an example of a “dashboard” visual map.

FIG. 10 illustrates an example of a “dashboard” visual map.

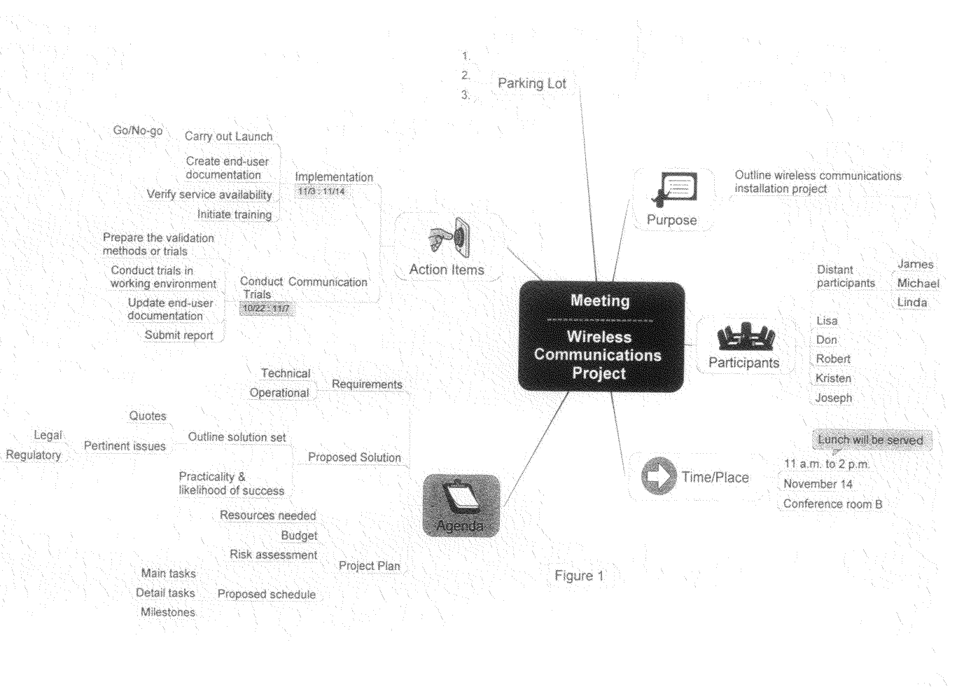

### DETAILED DESCRIPTION OF THE PREFERRED EMBODIMENTS

The visual mapping system of the present invention is based on a client-server architecture. The system includes a client visual mapping application through which a user can view, create, and edit topics in a visual map. The system also includes one or more servers that communicate with the client visual mapping applications to manage the storage and retrieval of topics and maps in the visual mapping system.

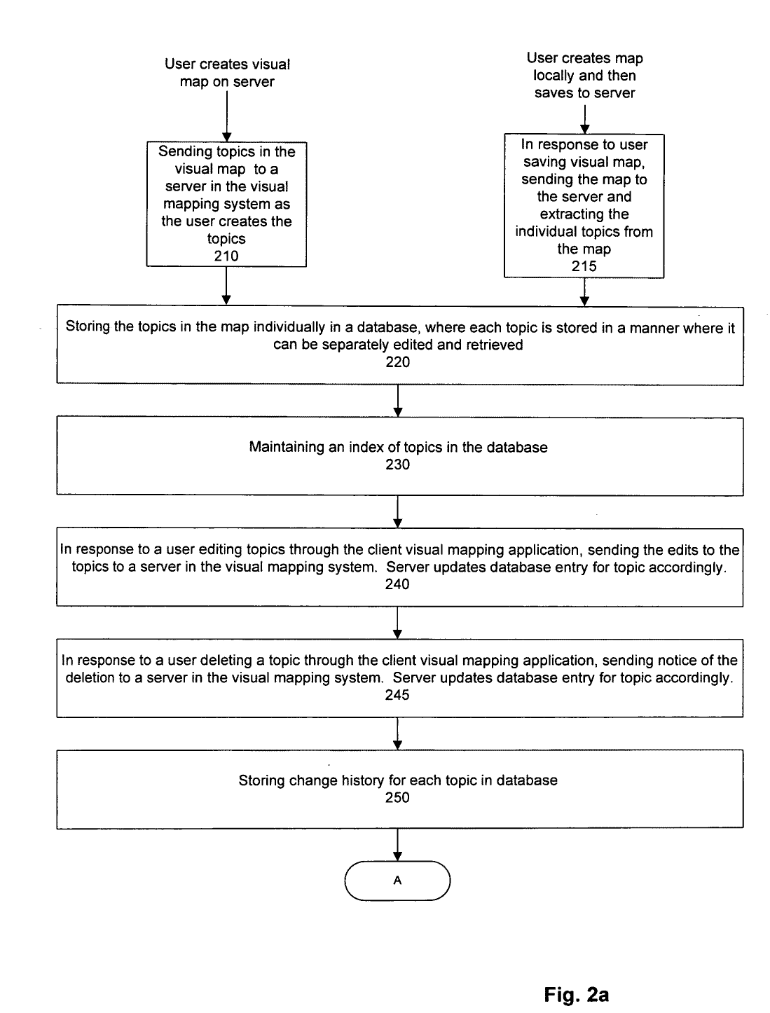

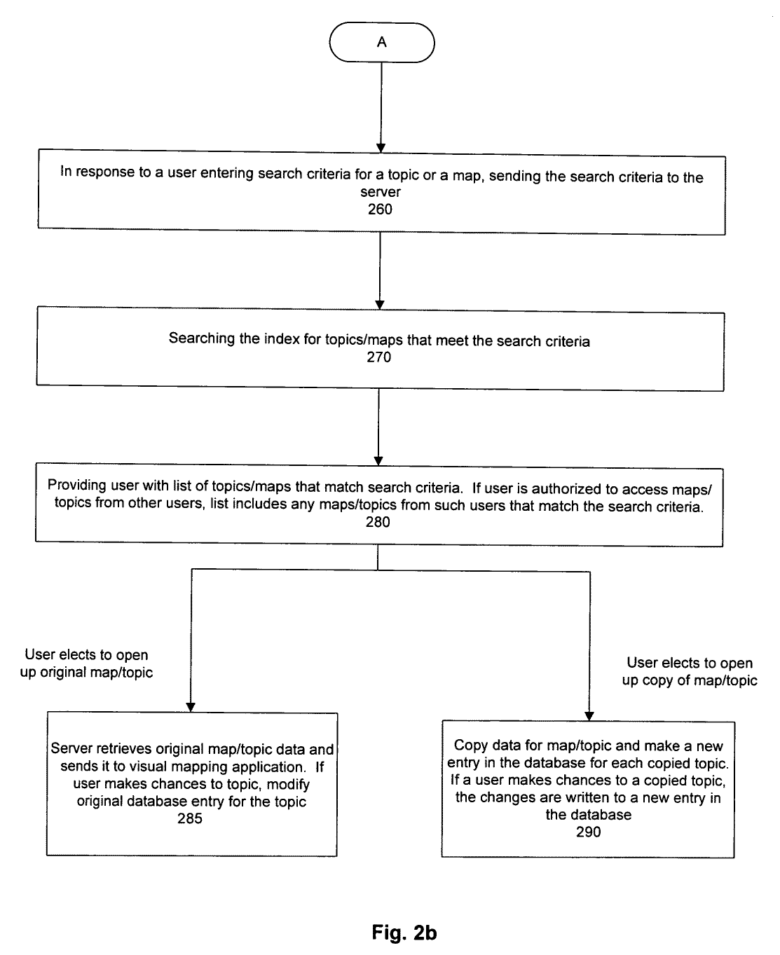

FIG. 2 illustrates a method, according to one embodiment of the present invention, for storing, searching, and retrieving topics in such a system. Those skilled in the art will appreciate that the steps in FIG. 2 need not necessarily be performed in the order shown.

When a user creates a visual map through the client visual mapping application, the user has the option of (1) having the map saved and updated on a server in the visual mapping system as the user is creating it, or (2) creating the map locally on the user's client computer and then later saving the map to a server in the visual mapping system. In the former case, each time a user creates a topic in the visual map, the client visual mapping application sends the topic to a server in the visual mapping system for storage (210). In the latter case, when the map is saved to the server, the client visual mapping application or the server extracts the individual topics from the visual map (step 215)

The server stores received topics individually in a database (step 220). Each topic is a separate entry in the database and can be separately edited and retrieved. As will be described in more detail below, the relationship between topics in a visual map is saved in the database, thereby enabling a client visual mapping application to load a visual map properly when it receives all the topics associated with a visual map. In one embodiment, which will be described with respect to FIG. 4, the server stores the topics by instructing a database system (e.g., a server running Oracle software) to store the topics in a database.

The server, or a database system with which the server communicates, creates and maintains an index of all topics in the database (step 230). Maintaining such an index enables topics to be quickly searched and retrieved.

Once a topic has been sent to a server, if a user subsequently edits the topic through the client visual mapping application, the client visual mapping application sends the edit to a server in the visual mapping system (step 240). If the user deletes a topic in a visual map through client visual mapping application, the client visual mapping application sends notice of the deletion to a server in the visual mapping system (245). The server then updates the database entry of the topic with the edit or deletion.

In one embodiment, a server in the visual mapping system stores the change history for each topic (step 250) in the database so that a user can retrieve the change history of each topic. Storing the change history can help ensure compliance with any government regulation or laws that require entities to track changes to certain data.

The client visual mapping application provides the user an interface through which a user can enter search criteria for a map or an individual topic. In response to a user entering search criteria for a map or topic, the client visual mapping application sends the search criteria to the server (step 260), which initiates a search of the index to find the desired topic or map (step 270).

The server provides the user (via the visual mapping application) with a list of topics or maps matching the search criteria (step 280). If the user is authorized to access maps or topics created by other users, the list of topics/maps can include topics and maps created by such other users. In one embodiment, the user has the option to open up the original map/topic or make a copy of the map/topic. If the user elects to open up the original map/topic, the server retrieves the original map/topic data from the database and sends it to the client visual mapping application (step 285). If the user subsequently makes changes to a topic, the original database entry for the topic is modified. If a user elects to make a copy of the original map/topic, a copy of the applicable topic(s) is made in the database, a new entry is made in the database for the copied topic(s), and the topic data is provided to the user (step 290). If a user subsequently makes changes to a copied topic(s), such changes are written to the new entry or entries in the database for the copied topic(s).

Since topics in a map are stored individually, retrieving a map comprises retrieving all the individual topics in the map, and copying a map comprises copying all the topics in the map.

Because topics are stored individually, they can be retrieved independent of the visual map in which they were created and, thus, the same topic can be shared across multiple maps and/or multiple users. For example, if a group of engineers are working on a project, and each engineer has a visual map that tracks the status of his/her portion of the project, then a project manager can create a new map (e.g., “a dashboard”) with select topics from each of the engineer's maps.

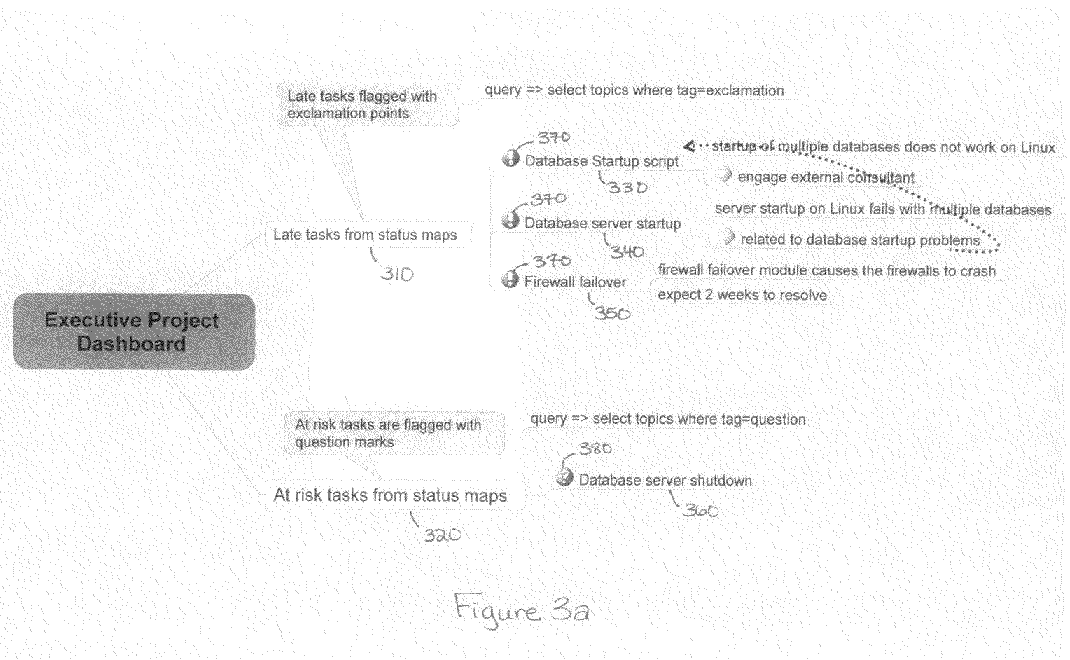

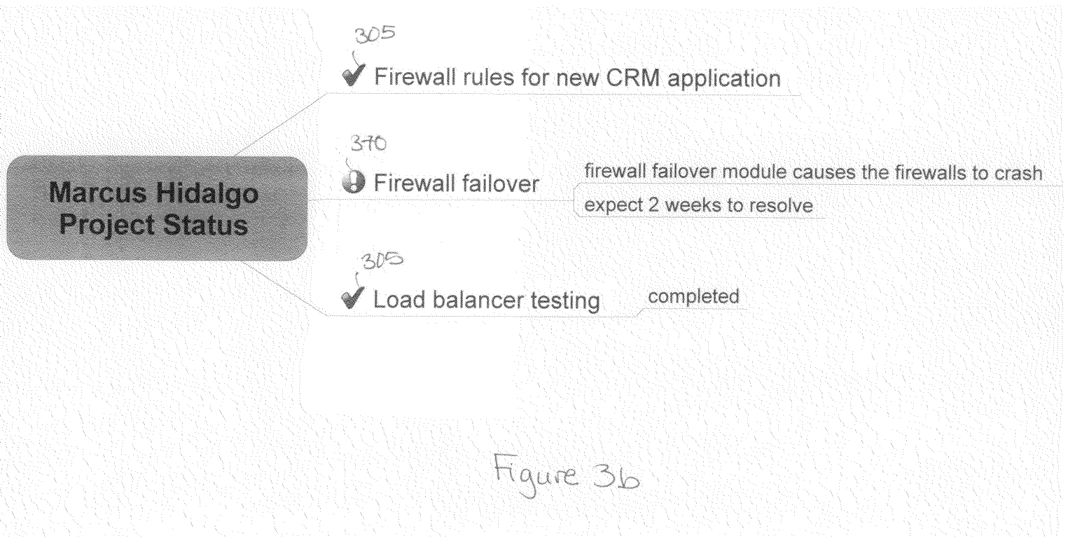

FIG. 3a, in conjunction with FIGS. 3b and 3c, illustrates an example of such a “dashboard” map. In this example, two engineers, Marcus Hidalgo and Jane Smith, have created maps showing the status of the tasks they are working on (FIG. 3b and 3c, respectively). Tasks that are on schedule or completed are tagged with a “checkmark tag” 305. Tasks that are at risk of running behind are tagged with a “question mark tag” 380, and tasks that are late are tagged with an “exclamation point tag” 370. The map in FIG. 3a is an example of what a person managing Marcus Hidalgo and Jane Smith might create to track their projects. In this example, the manager has created a query to load topics from the maps in FIGS. 3b and 3c that have question mark or exclamation tags 370, 380. Consequently, FIG. 3a illustrates the topics in Marcus Hidalgo's map (FIG. 3b) and Jane Smith's map (FIG. 3c) that are associated with either an exclamation point tag 370 or a question mark tag 380. Exclamation-point-tagged items are organized under topic 310, and question-mark-tagged items are organized under topic 320. The relationship 390 between topics 330 and 340 in FIG. 3b is also preserved and illustrated in FIG. 3a.

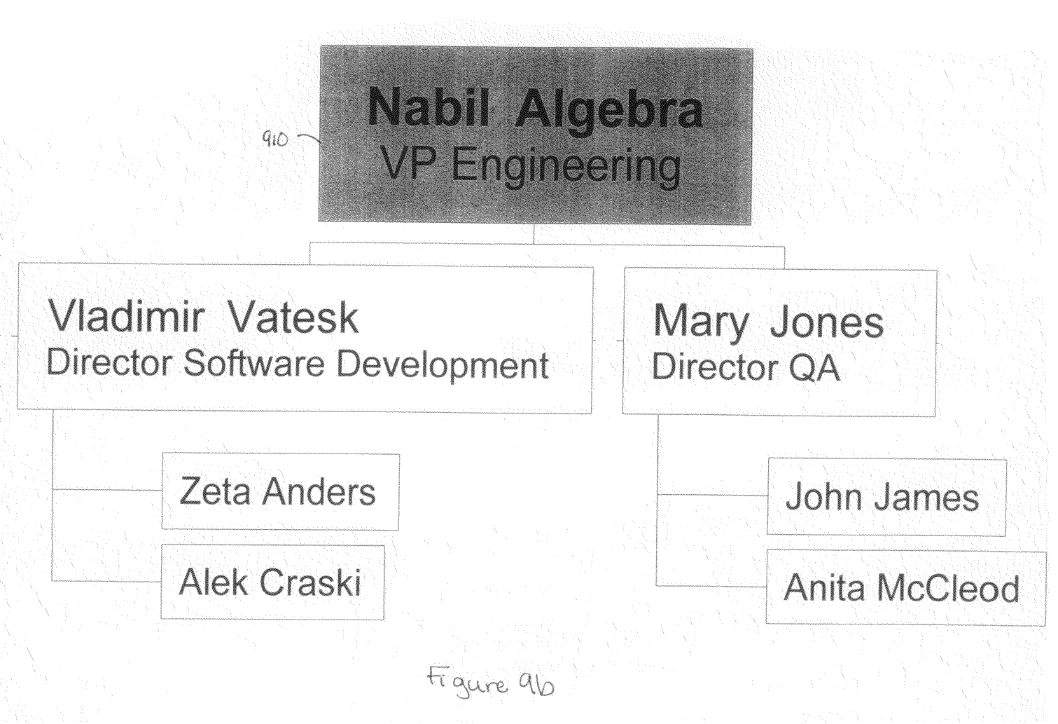

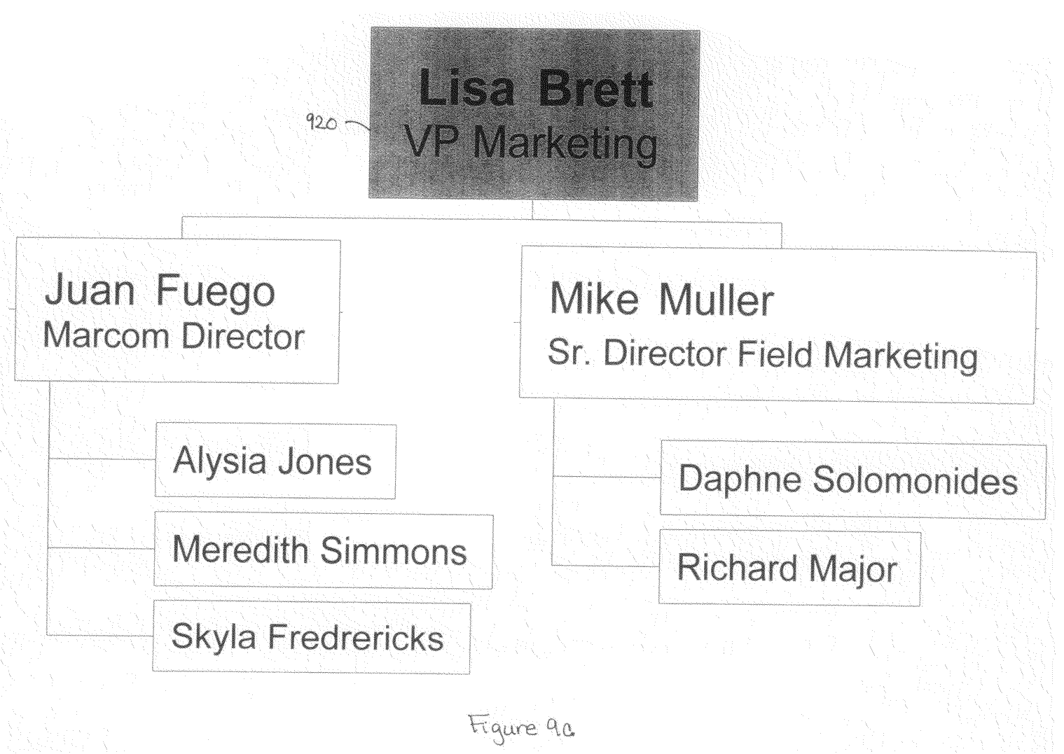

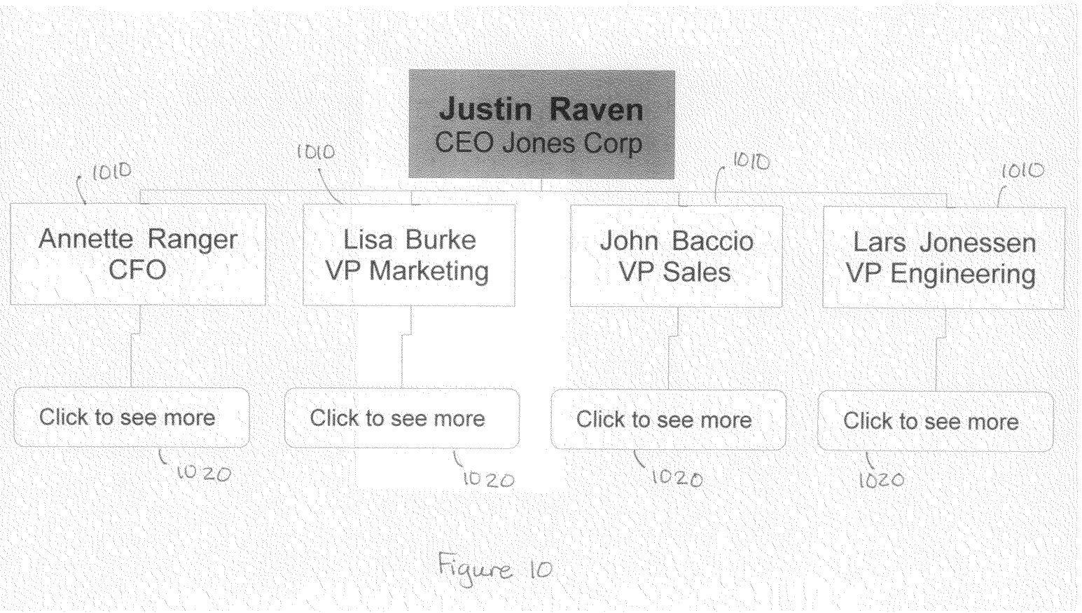

FIG. 9a illustrates another example of a “dashboard” map. FIG. 9a illustrates a company organization chart, where the map incorporates individual organization chart maps from departments in the company. In this example, it incorporates the organization charts for the engineering and marketing departments illustrated in FIGS. 9b and 9c, respectively. Specifically, it incorporates the central topics 910, 920 in FIGS. 9b and 9c. When the topics in FIGS. 9b and 9c are updated, FIG. 9a is automatically updated too.

FIG. 10 illustrates another “dashboard” company organization map. Like FIG. 9a, it also incorporates organization chart maps from each department in the company to create a company-wide organization chart. However, in this example, only the top-level topics 1010 from each department organization chart are initially loaded into the map. The user must click on one of topics 1020 to load further subtopics into the map.

Multiple users can view the same map simultaneously and edit different topics in the map at the same time. This allows group collaboration on a map. Because topics are stored individually in the database, two or more users viewing the same copy of a map can simultaneously edit different topics in the map, or different sections of the same topic. If two or more users attempt to edit the same topic (or same part of the same topic) at the same time, conflict rules can be applied to determine which changes take effect.

In one embodiment, a table with the change history for each topic is stored in the database, and the client visual mapping applications regularly poll this table to obtain updates to topics. If a change is made to a topic, the change is propagated to any other open map having the topic. In other words, the other topics are dynamically updated while open in a client visual mapping application, and other users viewing the topic can immediately see changes to the topic.

The visual mapping system may be configured to restrict access to certain maps or topics to certain users or workspaces. If so, when the server receives search criteria for a map or topic, it may limit its search to maps/topics that the user is authorized to access.

FIG. 4 is a block diagram of an example visual mapping system according to one embodiment of the present invention. The system includes client visual mapping applications 410, a visual mapping server 420, a database server 450, and a database 470. The visual mapping server 420 includes a server query module 430. The server query module 430 communicates with client mapping applications 410 to send and receive topics to client visual mapping applications 410. When the server query module 430 receives topics from client visual mapping applications 410, the server query module 430 sends the topics to a database query module 460 on the database server 450, which stores the topics in the database 470. The database query module 460 creates and maintains and index 465 of the topics stored in the database 470.

When a user searches for a map or a topic, the user's client visual mapping application 410 sends the search criteria to the server query module 430. The server query module 430 formulates a search query for the applicable topics and sends the query on to the database query module 460, which searches the index 465 for topics meeting the search criteria. A list of topics/maps meeting the search criteria is then sent to the server query module 430, which forwards the list to the applicable client visual mapping application 410. If a user wants to load a topic or map into the client visual mapping application, the client visual mapping application 410 requests the topic/map from the server query module 430, which then formulates an applicable query for the database query module 460. The database query module 460 retrieves from the database 470 the requested topic, or in the case of a map, the topics in the map, and sends them to the server query module 460, which passes them on to the applicable client visual mapping application 410. In one embodiment, the sever query module and the database query module communicate with each other via network 440, which may be a private network or the Internet (or a combination of both). In one embodiment, the client visual mapping application and the server query module communicate with each other via network 415, which may be a private network or the Internet (or a combination of both).

A client visual mapping application 410 may be a software application running on a user's computer or may be a browser-based application (where a user interfaces with the visual mapping server 420 through a web browser).

In one embodiment, the client visual mapping application 410 communicates with the server query module 430 using SOAP or other XML messages, the server query module 430 communicates with the database query module 460 in XML or SOAP, and the database query module 460 communicates with the database using SQL.

Those skilled in the art will appreciate that FIG. 4 illustrates one example of a visual mapping system of the present invention and there are other ways to implement a visual mapping system with a client-server architecture. For instance, there could be multiple servers serving the client visual mapping applications 410. Moreover, the server query module 430 and the database query module 460 could reside on the same server. Furthermore, topics can be stored in more than one database (e.g., there can be multiple databases connected through a network).

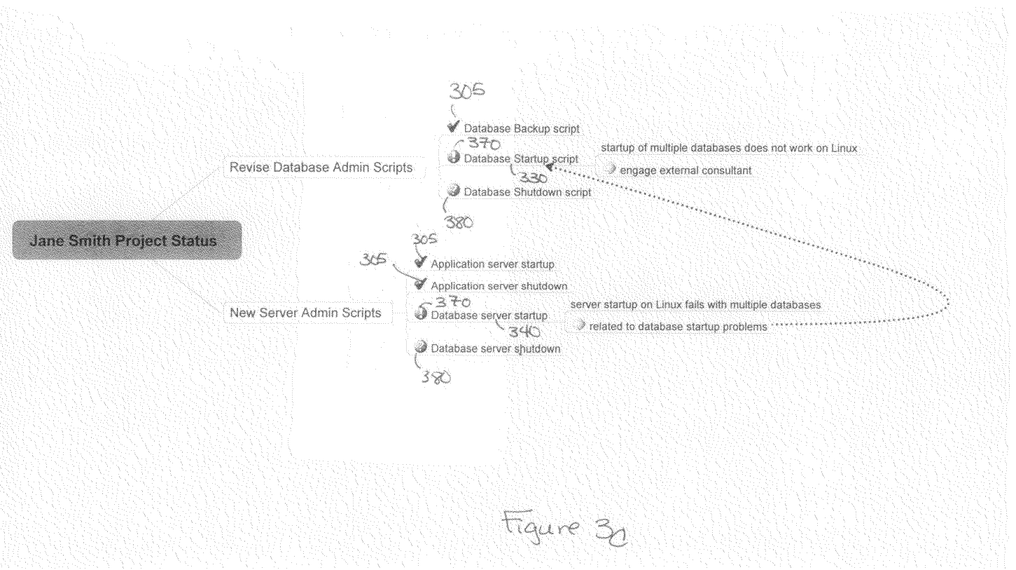

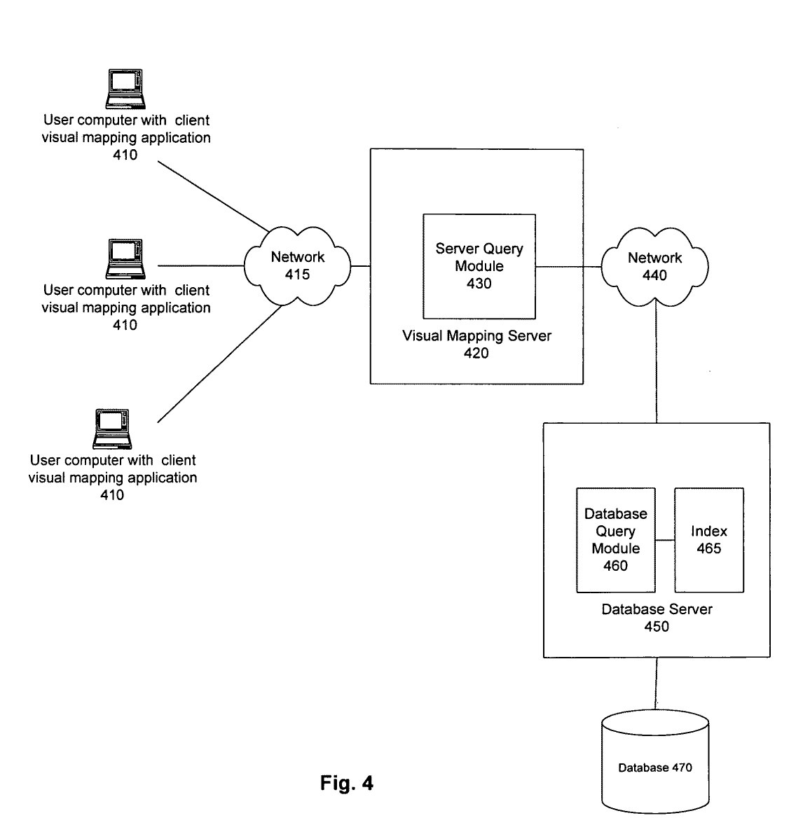

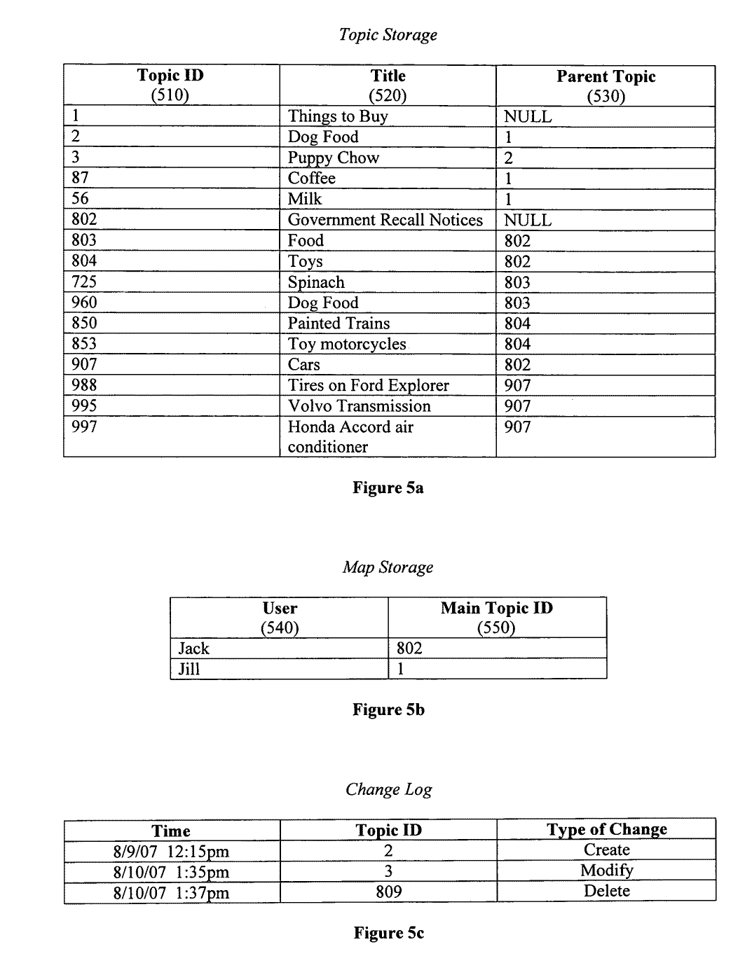

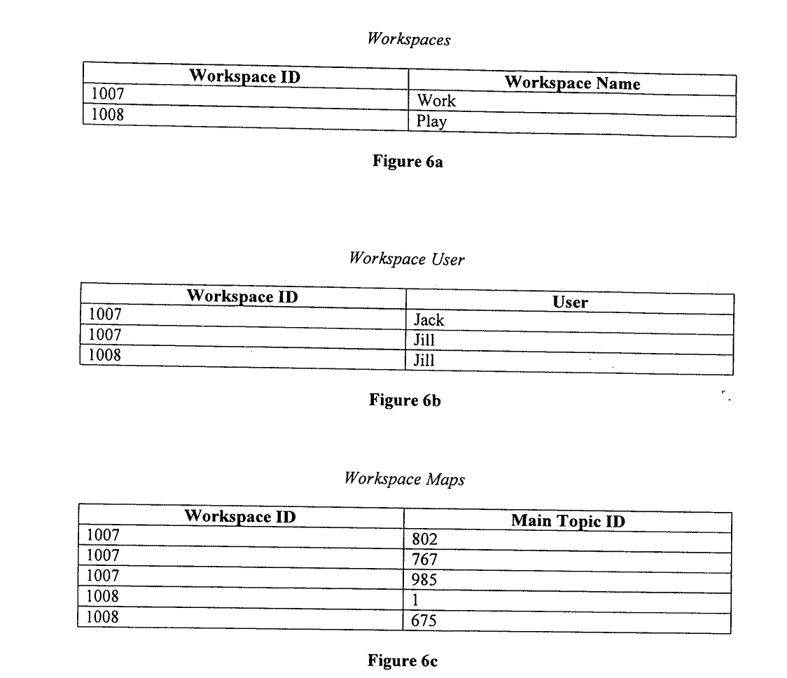

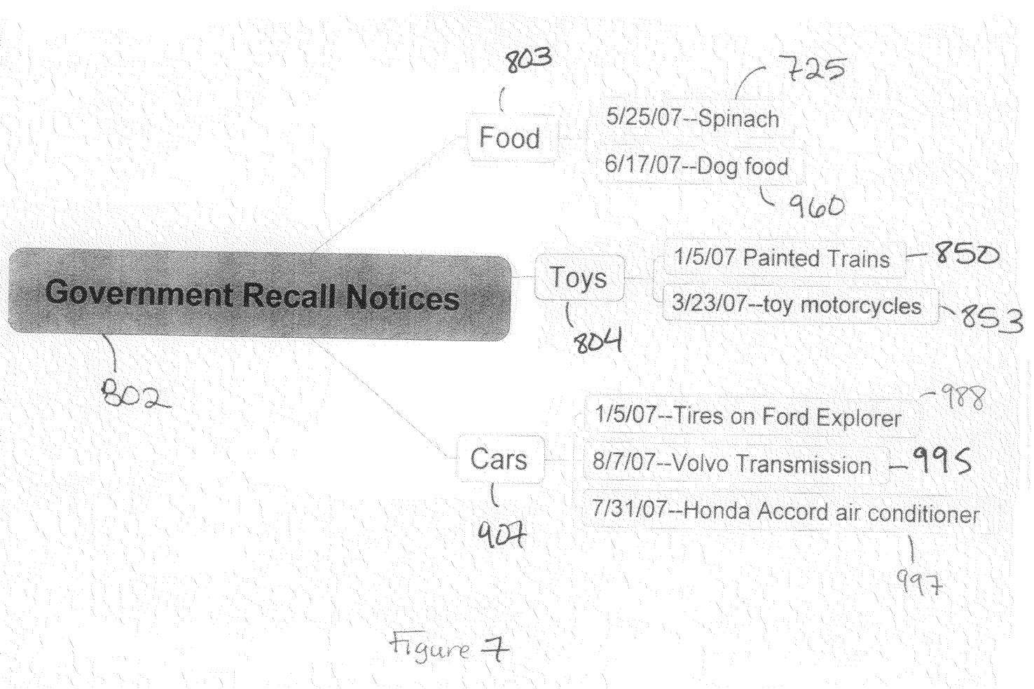

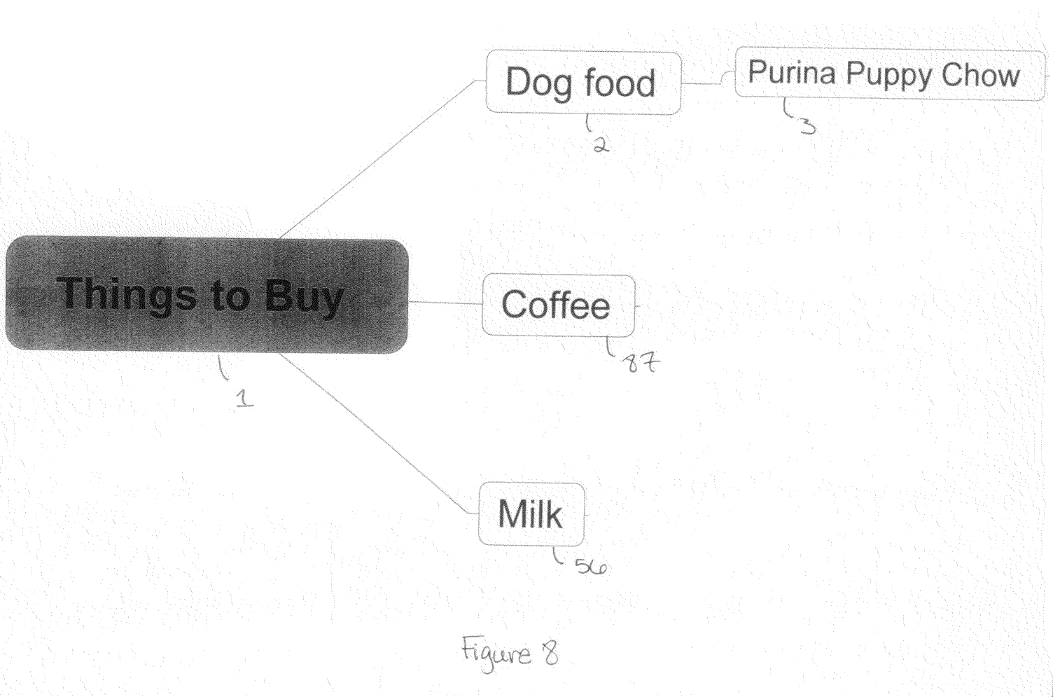

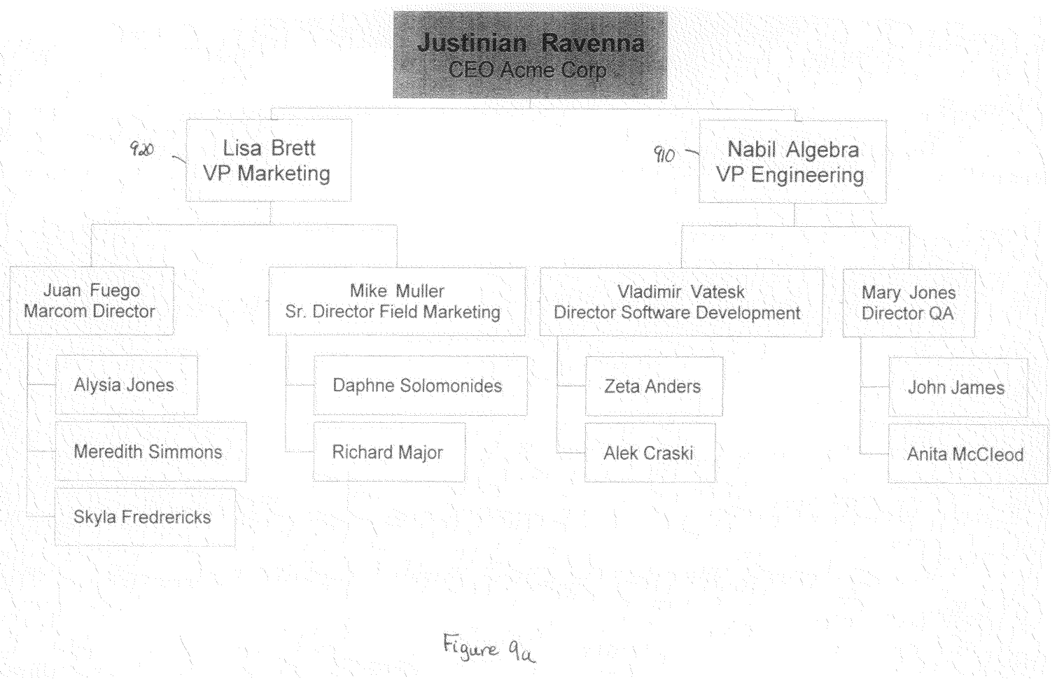

FIG. 5a-5c and 6a-6b are example, simplified tables that illustrate how topics, maps, and workspaces can be stored in a database. These examples are described with respect to the example maps in FIGS. 7 and 8. In the illustrated embodiment, topics are stored in tables. FIG. 5a is an example of a table for storing maps. The table includes a column for topic ID 510, topic title 520, and the parent topic ID 530. Each topic is associated with a unique ID. For the purposes of this example, the reference numbers in FIGS. 7 and 8 are the same as the unique IDs. Column 510 stores the topic ID, column 520 stores the title of the topic, and column 530 lists any direct parent topic of a topic. For instance, the central topic “Things to Buy” in FIG. 8 has topic ID “1”. Since it does not have a parent topic, “NULL” is in the database entry for the Parent Topic column 530. The topic called “Purina Puppy Chow” has the topic “Dog Food” with topic ID “2” as a parent, and, therefore, “2” is the entry in Parent Topic ID column 530 for the “Purina Puppy Chow” topic 3. FIG. 5a shows only three columns for simplicity purposes, but the topic table could store much more information about topics and have many more columns, such as columns that have flag information, topic class information, comments, the date created, etc.

FIG. 5b illustrates an example of how maps are stored. In this embodiment, a map is just the central or primary topic in the map from to which all other topics directly or indirectly connect. The table in FIG. 5b has two columns. Column 540 lists the users that created each map, and column 550 lists the topic ID of the main topic in the visual map. In this example, user Jack has created the map “Government Recall Notices” where the primary topic has topic ID “802.” User Jill has created the map “Things to Buy” where the primary topic has topic ID “1.”

FIG. 5c illustrates a Change Log table. The Change Log table lists each change associated with a topic. For instance, the table shows that the topic with topic ID “2” (“Dog Food” in FIG. 8) was created at 12:15 pm on Aug. 9, 2007. The table also shows that the topic with topic ID “3” (“Purina Puppy Chow” in FIG. 8) was modified at 1:35 pm on Aug. 10, 2007, and that a topic with topic ID “809” was deleted at 1:37 pm on Aug. 10, 2007. The Change Log table enables users to see the change history of each topic. FIG. 5c illustrates a simple Change Log table, but Change Log table could include much more detail about changes. For instance, there could be a “user” column that indicates who made the change, and there could be a column that specifies the details of the change.

In one embodiment, the visual mapping system supports workspaces, where users belonging to a workspace can share documents in the workspace. Workspaces are assigned IDs, and FIG. 6a illustrates a table database that relates a workspace ID to its name. In this example, there are two workspaces, one labeled “Work” and one labeled “Play”. FIG. 6b illustrates table that stores the names of users that are associated with each workspace. Both Jill and Jack belong to the workspace “Work” and Jill belongs to the workspace labeled “Play.”

FIG. 6c is a table that relates each workspace to a map by relating each workspace to the main topic ID for the map (e.g., the central topic). In this example, workspace “1007” (“Work”) includes maps having main topic IDs “802,” “764” (map not shown), and “985” (map not shown). Workspace “1008” (“Play”) includes maps having main topic IDs “1” and “675” (map not shown).

As will be understood by those familiar with the art, the invention may be embodied in other specific forms without departing from the spirit or essential characteristics thereof. Accordingly, the above disclosure of the present invention is intended to be illustrative and not limiting of the invention.

1. In a visual mapping system, a method for enabling a user to search and retrieve topics in a visual map on an individual basis, the method comprising:
providing a client visual mapping application through which a user can view, create, and edit topics in a visual map;
in response to a user creating topics through the client visual mapping application, sending the created topics to a server in the visual mapping system;
storing the created topics individually in a database, where each of the created topics is stored in a manner that enables the topic to be separately retrieved, viewed, and edited;
maintaining an index of all topics in the database;
in response to a user editing a topic stored in the database through the client visual mapping application, sending the edit to a server in the visual mapping system;
in response to a user deleting a topic stored in the database through the client visual mapping application, sending notice of the deletion to a server in the visual mapping system;
providing in the client visual mapping application an interface through which a user can search for topics individually in the database;
in response to a user entering search criteria for a topic search, sending the search criteria to a server in the visual mapping system;
searching the index for topics in the database satisfying the search criteria; and
enabling the user to load one or more topics matching the search criteria into a visual map.

2. The method of claim 1, wherein a topic in the database can be loaded into a visual map that is different from the visual map in which the topic was created.

3. The method of claim 1, wherein topics in the database can be shared across a plurality of maps.

4. The method of claim 1, wherein topics in the database can be shared by a plurality of users.

5. The method of claim 1, wherein the created topics are sent to the server as the user creates such topics in the visual map.

6. The method of claim 1, wherein the created topics are sent to the server when the user saves the visual map containing such topics to the server.

7. The method of claim 1, wherein enabling the user to load one or more topics matching the search criteria into a visual map comprises:
providing the user with a list of topics that match the search criteria; and
for each topic in the list, providing the user with the option to open up the original topic.

8. The method of claim 7, further comprising:
if the user elects to open up an original topic, retrieving data for the topic from the database, and, if a user makes and saves changes to the topic, modifying the original database entry for the topic.

9. The method of claim 7, further comprising also providing the user with option to copy a topic, and, in response to the user electing to make a copy of the topic, making a new entry in the database for the copy of the topic.

10. The method of claim 7, further comprising also providing the user with option to move a topic.

11. The method of claim 1, further comprising enabling a plurality of users to share a visual map and to edit different topics in the visual map simultaneously, wherein each of the plurality of users views the visual map through a client visual mapping application.

12. The method of claim 11, wherein, when one of the plurality of users edits a topic in the shared visual map, the change to the topic is propagated to the client visual mapping applications of the other users to enable all of the plurality of users to see the change.

13. The method of claim 12, wherein a server in the visual mapping system maintains a table of changes to the topics in the database, and client visual applications in the visual mapping system poll this table to obtain updates to relevant topics in the database.

14. The method of claim 1, wherein each topic has a change history, and wherein one or more servers in the visual mapping system maintains a change history for each of the topics by maintaining a table in the database that documents the changes to each topic.

15. A visual mapping system comprising:
a client computer with a client visual mapping application that provides an interface through which a user can view, edit, and create visual maps and through which a user can enter search criteria to search for one or more topics;
a database for storing topics in visual maps, where the topics are stored individually; and
a server, connected via a network to the client computer, for storing topics in the database individually, for initiating searches for topics in response to receiving search criteria from the client visual mapping application, and for retrieving topics in the database and sending topics to the visual mapping application.

16. The system of claim 15, further comprising a database server through which the server accesses the database, wherein the database server sends search requests to the database and maintains an index of topics stored in the database.

17. A computer program embodied on a computer-readable medium and comprising code, that, when executed by a computer, enables the computer to perform the following method:
receiving topics created in a visual mapping system;
storing the created topics individually in a database, where each of the created topics is stored in a manner that enables the topic to be separately retrieved, viewed, and edited;
maintaining an index of all topics in the database;
in response to receiving an edit to a topic in the database, updating the data for the topic in the database;
receiving search criteria for topics in the database from a client visual mapping application;
searching the index for individual topics in the database that match the search criteria;
sending a list of topics matching the search criteria to the client visual mapping application;
receiving a request to retrieve one or more of the topics from the list from the client visual mapping application; and
sending the requested topics to the client visual mapping application.

18. The computer program of claim 17, wherein a topic can be loaded into a visual map that is different from the visual map in which the topic was created.

19. The computer program of claim 17, further comprising enabling individual topics in the database to be shared by a plurality of visual maps.

20. The computer program of claim 17, further comprising enabling individual topics in the database to be shared by a plurality of users.

21. The computer program of claim 17, further comprising enabling a user to modify either an original version of a topic matching the search criteria or a copy of a topic matching the search criteria.

22. The computer program of claim 17, further comprising maintaining a table in the database that documents the change history of each topic in the database.
